(19) United States
(12) Patent Application Publication
(10) Pub. No.: US 2016/0123813 A1
(43) Pub. Date: May 5, 2016

(54) SPECTRAL MICROSCOPY DEVICE

(71) Applicant: CANON KABUSHIKI KAISHA, Tokyo (JP)

(72) Inventor: Masafumi Kyogaku, Yokohama-shi (JP)

(21) Appl. No.: 14/891,614

(22) PCT Filed: May 21, 2014
(86) PCT No.: PCT/JP2014/002675

§ 371 Date: Nov. 16, 2015

(30) Foreign Application Priority Data
May 29, 2013 (JP) 2013-113147

(51) Int. Cl. G01J 3/44; G01J 3/06; G02B 21/00

(52) U.S. Cl. CPC G01J 3/4412; G02B 21/002; G01J 3/06

(57) ABSTRACT

A spectral microscopy device includes a spectral detecting unit including a light source that is capable of controlling an output wavelength, a microscope section that is provided with an observation area that is illuminated with light output from the light source, and a signal detector that detects light from the observation area as spectral data; a moving unit configured to move the observation area; and a controller that performs a control operation to allow the spectral detecting unit and the moving unit to move in response to each other. The spectral microscopy device is controlled so that switching between different measurement conditions is performed at an observation area movement time in which the observation area is moved by the moving unit and measurement is performed and at an observation area movement stoppage time in which the observation area is fixed and measurement is performed.

### TECHNICAL FIELD

The present invention relates to a spectral microscopy device that measures a spectral image of a measurement object.

### BACKGROUND ART

In recent years, spectral microscopies making use of nonlinear optical phenomena have been developed, and are expected to be applied as units configured to observe matter distribution in a living body. These microscopes make use of various nonlinear optical phenomena such as the generation of sum-frequency and multi-photon absorption.

Nonlinear Raman spectral microscopies that obtain information regarding vibration of molecules are being developed.

In nonlinear Raman scattering, when laser light beams having two wavelengths are focused and the difference between the frequencies of the laser light beams matches the frequency of the vibration of the molecules of a specimen, a phenomenon in which a specific scattering occurs at the focus point is made use of.

These microscopes are scanning optical microscopes that cause a very strong light, such as laser light, to converge on a specimen and detect scattered light while moving a measurement point on the specimen.

It is possible to form spectral microscopy that obtains a spatial distribution of a spectrum by changing light wavelengths.

As a nonlinear Raman spectral microscopy, a coherent anti-stokes Raman scattering microscopy is known. As another example thereof, a stimulated Raman scattering spectral microscopy is disclosed in NPL 1. The stimulated Raman scattering spectral microscopy is capable of obtaining at a high speed a spatial distribution of a Raman scattering spectrum while performing wavelength sweeping at a high speed.

According to these technologies, since considerably stronger signals can be obtained than those that are obtained when spontaneous Raman scattering technology is used, these technologies are effective in obtaining spectral images at a high speed.

PTL 1 describes techniques for differentiating structural components by performing a multivariate analysis, such as a principal component analysis, on a Raman scattering spectrum. These techniques make it possible to divide and display pieces of information for corresponding cellular structure or constitutive materials with respect to, for example, unstained biological tissue.

### CITATION LIST

### Patent Literature

PTL 1: Japanese Patent Laid-Open No. 2011-196853

### Non Patent Literature

NPL 1: Nature Photonics 6, 845-851, 2012

The above-described existing spectral microscopies have the following problems. That is, in order to obtain precise spectral distributions, it is necessary to obtain data by changing many measurement wave numbers for many measurement points in space, as a result of which it takes a long time to perform measurements.

When multivariate analysis, such principal component analysis, is further performed on the obtained data, if there are many measurement wave numbers, a large amount of time is required for the analysis in addition to the measurement.

Therefore, when making an observation while moving an observation area, such as when finding a desired observation area, it is difficult to speedily display the results of the analysis with good followability with respect to the movement of the observation area.

### SUMMARY OF INVENTION

The present invention provides a spectral microscopy device that is capable of speedily displaying results of an analysis with good followability with respect to an area movement when making an observation while moving an observation area, such as when finding a desired observation area.

### Solution to Problem

A spectral microscopy device according to the present invention includes a spectral detecting unit including a light source that is capable of controlling an output wavelength, a microscope section that is provided with an observation area that is illuminated with light output from the light source, and a signal detector that detects light from the observation area as spectral data; a moving unit configured to move the observation area; and a controller that performs a control operation to allow the spectral detecting unit and the moving unit to move in response to each other. The spectral microscopy device is controlled so that switching between different measurement conditions is performed at an observation area movement time in which the observation area is moved by the moving unit and measurement is performed and at a movement stoppage time in which the observation area is fixed and measurement is performed.

According to the present invention, it is possible to realize a spectral microscopy device that is capable of speedily displaying results of an analysis with good followability with respect to an area movement when making an observation while moving an observation area.

Further features of the present invention will become apparent from the following description of exemplary embodiments with reference to the attached drawings.

### BRIEF DESCRIPTION OF DRAWINGS

FIG. 1 is a schematic view for describing an exemplary structure of a spectral microscopy device according to a first embodiment of the present invention.

FIG. 2 is a schematic view showing switching between a measurement condition when an observation area is moved and a measurement condition when the observation area is fixed in the first embodiment of the present invention.

FIG. 3A is a view for describing an exemplary structure that allows a measurement condition in the first embodiment according to the present invention to be switched on the basis of a measurement wave number, and schematically shows switching of the measurement condition when the observation area is moved.

FIG. 3B is a view for describing the exemplary structure that allows a measurement condition in the first embodiment according to the present invention to be switched on the basis of a measurement wave number, and schematically shows switching of the measurement condition when the observation area is fixed.

FIG. 4A is a view for describing an exemplary structure of a stimulated Raman spectral microscopy device according to a second embodiment of the present invention, and is a schematic view of functions according to the second embodiment of the present invention.

FIG. 4B is a view for describing the exemplary structure of the stimulated Raman spectral microscopy device according to the second embodiment of the present invention, and is a schematic view showing a microscope section in more detail.

FIG. 5 is a schematic view for describing an exemplary structure that changes a wave number domain to, for example, a fingerprint region or a CH stretching region according to a fourth exemplary embodiment of the present invention.

FIG. 6 is a schematic view for describing an exemplary structure that moves an observation area in a two-dimensional plane (X and Y directions) according to a fifth exemplary embodiment of the present invention.

FIG. 7 is a schematic view showing movement of an observation area at the time of specification of a fixed observation area, a preview display, and movement of the observation area in a ninth embodiment of the present invention.

### DESCRIPTION OF EMBODIMENTS

Next, spectral microscopy devices according to several embodiments of the present invention are described. However, the present invention is not limited to the structures according to these embodiments.

### First Embodiment

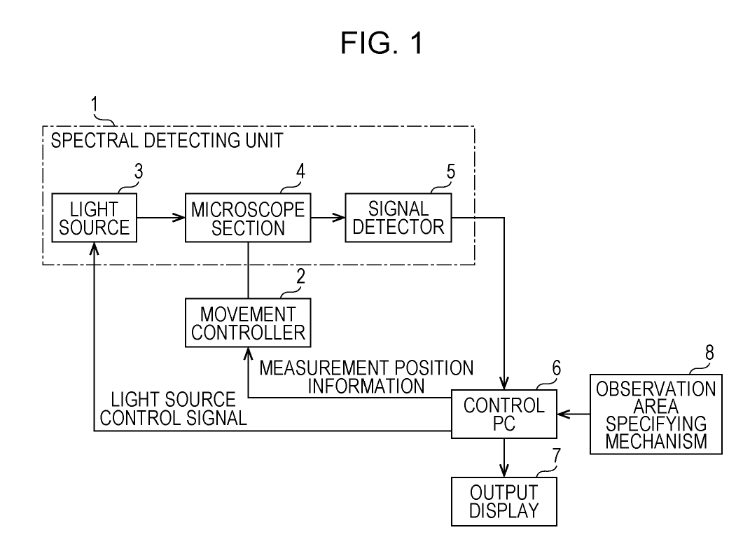

An exemplary structure of a spectral microscopy device to which the present invention is applied is described as a first embodiment with reference to FIG. 1.

As shown in FIG. 1, the spectral microscopy device according to the embodiment includes a spectral detecting unit 1, a movement controller (moving unit) 2, a control PC 6, an output display 7, and an observation area specifying mechanism 8. The spectral detecting unit 1 includes a light source 3, a microscope section 4, and a signal detector 5.

The light source 3 is a laser light source or other light sources. For example, a light source configured to be capable of changing or selecting a wavelength (light source that is capable of controlling an output wavelength) is included among such light sources.

The types of light source are not limited, so that it is possible to select light sources from light sources having a wavelength ranging from a millimeter wave region to an X-ray region.

The control PC 6 outputs measurement wave number information and information regarding measurement positions on a specimen.

The light source outputs light of a previously selected wavelength.

The movement controller 2 connected to the microscope section 4 receives the measurement position information from the control PC 6, and moves the position of the specimen that has been set in the microscope section 4.

Light introduced into the microscope section 4 from the light source 3 scans and illuminates the specimen. Light that has exited from the specimen is detected by the signal detector 5.

The control PC 6 generates and stores data in which position information, wavelength information, and signals from the signal detector 5 have been integrated.

Further, when measurements are made by changing the wavelength of the light source, it is possible to obtain a spatial distribution of a spectrum.

A signal analyzing unit that analyzes spectral data and outputs the result of analysis to the output display 7 is formed at the control PC 6.

At this time, the result of analysis that is displayed is a spectral image in which a signal strength distribution for a certain wave number is spatially mapped. Alternatively, the result of analysis that is displayed may be displayed, for example, by color in correspondence with a component of a specimen that is measured.

Although, a general peak detection technique or the like may be used as the spectrum analyzing technique, the spectrum analyzing technique is not limited thereto. In order to speed up the measurement and analysis, part of the processing operation including data analysis can be performed at the control PC 6 by, for example, field programmable gate array (FPGA) or application specific integrated circuit (ASIC).

Here, if the number of light sources, the wavelengths of the light sources, and the wavelengths of detected light are selected as appropriate, it is possible to select and detect signals based on nonlinear optical phenomenon, such as a multi-photon absorption signal, a sum-frequency generation signal, a difference-frequency generation signal, a stimulated Raman scattering signal, and a coherent antistokes Raman scattering signal.

Examples of cases in which one light source is used include two-photon absorption and second harmonic generation.

Examples of cases in which two light sources having different wavelengths are used include sum frequency generation, difference frequency generation, two-wavelength type multi-photon absorption, stimulated Raman scattering, and coherent antistokes Raman scattering.

A spectrum is frequently represented by a signal value with respect to a wave number.

The definition of wave number slightly differs depending upon the measurement method. In spectroscopy using one light source, the wave number is a reciprocal of a measurement wavelength. In the case where two types of light sources are used, such as in nonlinear Raman scattering spectroscopy, the measurement wave number is the difference or the sum of the reciprocals of the wavelengths of the two light sources.

In the latter case, a plurality of combinations of wavelengths of two light sources can be obtained with respect to one wave number. When the measurement wave number is to be changed, the wavelengths of the light sources are changed or selected as appropriate. However, when the wavelength of one of the light sources is fixed, the change in the wave number is in correspondence with only the change in the wavelength of the other of the light sources.

When operating the spectral microscopy device, an operator operates the observation area specifying mechanism 8, drives the movement controller 2, and moves an observation area on a specimen.

Here, the term “observation area” refers to an area that is illuminated with light, and that is specified generally horizontally on a surface of the specimen.

As the observation area specifying mechanism 8, an input device, such as a mouse and a keyboard, may also be used. The observation area specifying mechanism 8 may be a dedicated device including, for example, a joystick or a track ball. In an observation area, for example, light scans a surface of the specimen to obtain a spectral signal two-dimensionally. The observation area can be moved by moving a stage, moving a light scanning region, or by performing a combination of these as appropriate. However, the method of moving the observation area is not particularly limited.

An entire observation area is primarily defined on the basis of a movable range of a mechanism used for moving the observation area.

The spectral microscopy device according to the embodiment is controlled so that the spectral detecting unit and the moving unit are movable in response to each other by the control PC 6.

That is, the spectral microscopy device is configured to allow, in response to the movement controller 2, switching between a spectral measurement condition when an observation area is moved and a spectral measurement condition when the observation area is fixed.

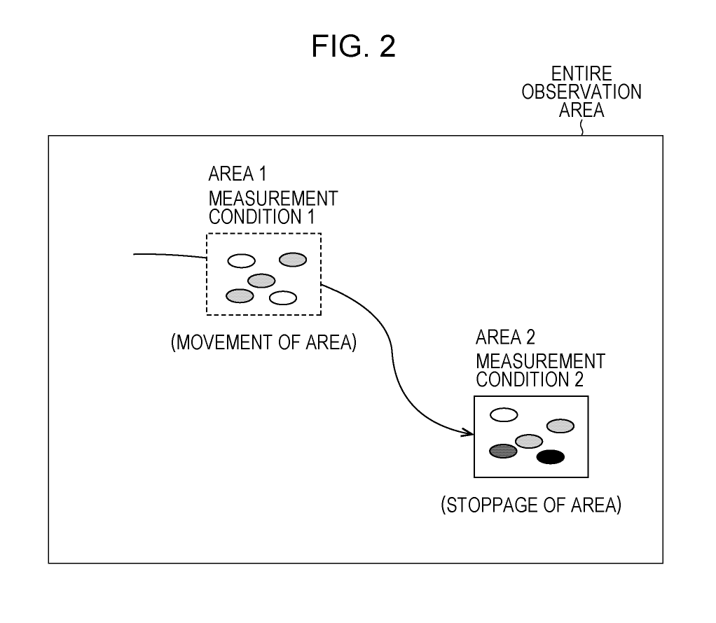

FIG. 2 is a schematic view showing switching between a measurement condition when an observation area is moved and a measurement condition when the observation area is fixed.

That is, measurement is performed under a measurement condition 1 in an area 1 when an observation area is moved, and the measurement condition 1 is switched to a measurement condition 2 in an area 2 when the observation area is fixed.

The spectral microscopy device according to the embodiment may be configured to detect a movement state and a stopped state of an observation area and automatically switch the measurement condition.

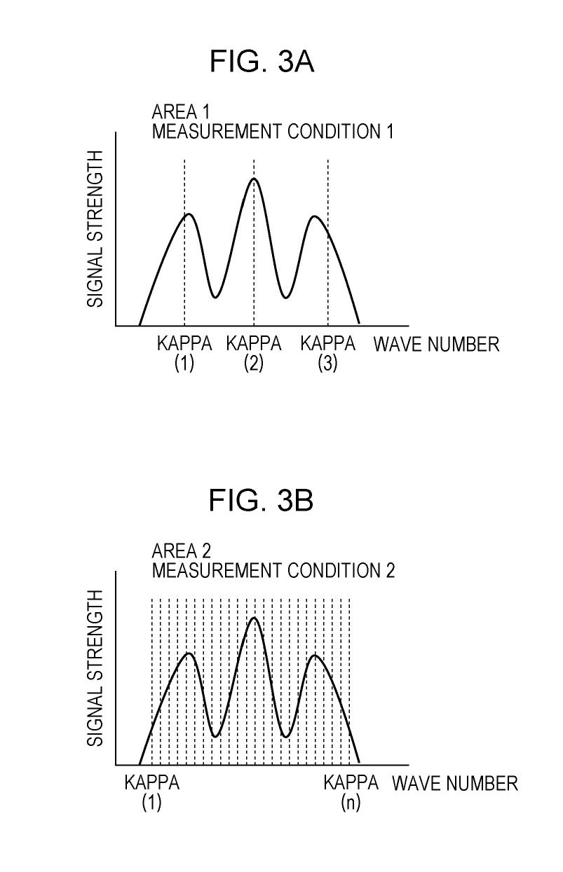

An exemplary structure that allows a measurement condition to be switched to be such that the number of measurement wave numbers that are selected is switchable is described using FIGS. 3A and 3B.

FIGS. 3A and 3B are each a schematic view of a spectrum that is measured at a certain measurement point. Here, kappa(n) represents an nth measurement wave number that is measured.

(1) When an observation area is moved: the number of measurement wave numbers that are selected is set small (see FIG. 3A). However, when a multivariate analysis described below is performed on measurement data, the number of wave numbers is at least 2. The movement of the observation area is stopped until the measurement under a set condition is completed. That is, movement in steps is repeated. The results of analysis may be identified and displayed, for example, by color as a component distribution.

(2) When an observation area is fixed (or when movement of the observation area is stopped): the number of wave numbers that are selected is set larger than the set number when the observation area is moved (see FIG. 3B). By setting a large number of measurement wave numbers, it is possible to obtain a more detailed spectrum. At this time, it takes time to perform the measurement and analysis. However, since the observation area is fixed, followability with respect to the movement does not become a problem.

For the case in which an observation area is moved or in which the observation area is fixed, the wave number values and the number of measurement wave numbers that are selected are previously set. Here, it is possible to specify an entire wave number range that is measurable and assign the wave numbers at equal intervals in accordance with the number of measurement wave numbers that are selected set within this range. Alternatively, it is also possible to set particular wave numbers and set the wave numbers at unequal intervals. In this case, the wave numbers may be selected using information regarding spectrum of a known material. Still alternatively, the wave number values and the number of measurement wave numbers that are selected may be determined for the case in which the observation area is fixed on the basis of results of measurement and results of analysis when the observation area is moved.

Spectral resolution is reduced when the number of measurement wave numbers is small. However, it is still possible to distinguish between different types of materials even though the capacity to identify the materials is reduced. Therefore, sufficient information can be obtained for the purpose of, for example, finding a detailed observation area while moving an observation area.

In particular, if two wave numbers or several wave numbers are measured, it only takes a short time to perform the measurement and analysis. Therefore, it is possible to substantially perform real-time display by following the movement of the observation area. Consequently, it can be used as a preview image that is used for searching for an area to be observed in detail and whose display is not delayed.

In contrast, when the number of measurement wave numbers is increased, the amount of measurement time and analysis time are increased in accordance with the number of measurement wave numbers. Therefore, although followability of the display of results with respect to the movement of the observation area is reduced, it is possible to perform more detailed identification and display. An operator may set, as appropriate, the number of wave numbers that are selected considering the amount of measurement time and analysis time.

When the observation area is fixed, for example, measurements may be made by stopping the movement of the observation area after the observation area has moved. Here, it takes time to perform measurement and analysis when the number of measurement wave numbers that are selected is large. However, since the observation area is fixed, followability with respect to the observation area does not become a problem.

When a signal is weak, in order to increase the S/N ratio, it is effective to perform measurements a plurality of times for the same measurement wave number and integrate output signals. Accordingly, the number of integrations may be changed by fixing the number of measurement wave numbers that are selected. Alternatively, it is possible to change the number of wave numbers that are selected and the number of integrations.

The number of integrations when the observation area is moved and the number of integrations when the observation area is fixed may be previously set. The number of integrations when the observation area is fixed may be determined on the basis of the results of measurement or the results of analysis when the observation area is moved.

In a preview screen when an observation area is moved, since followability with respect to the movement of the observation area is required, the number of integrations cannot be made large. However, since followability does not become a problem when the observation area is fixed, a large number of integrations can be set for prioritizing accuracy in identification of a substance.

According to the embodiment, images of the measurement results can be speedily displayed with good followability with respect to the movement of the observation area while moving the observation area. Therefore, it becomes easy to search for an area to be subjected to a desired detailed observation.

### Second Embodiment

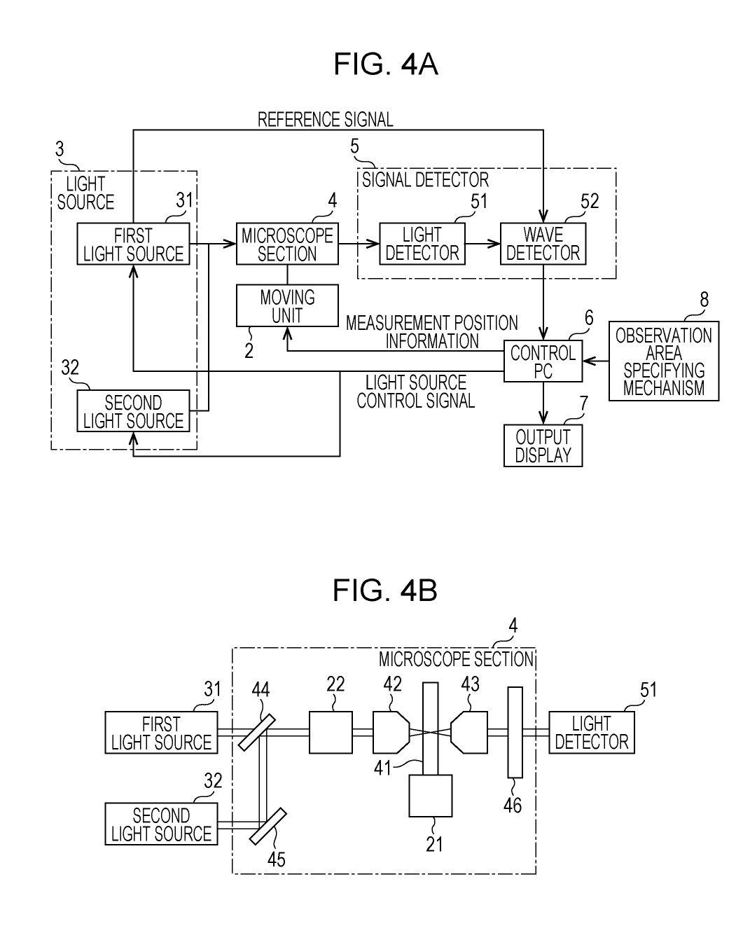

An exemplary structure of a stimulated Raman spectral microscopy device to which the present invention is applied is described as a second embodiment with reference to FIGS. 4A and 4B. FIG. 4A is a schematic view of functions according to the second embodiment of the present invention. FIG. 4B is a schematic view showing a microscope section in more detail.

The spectral microscopy device according to the present invention can be formed not only as the aforementioned stimulated Raman spectral microscopy device, but also can be easily formed as a coherent anti-stokes Raman scattering spectral microscopy device if an optical filter is changed to one that can remove incident light. Further, if an appropriate optical filter is selected, the spectral microscopy device according to the present invention can be formed as various other types of microscope devices, such as a multi-photon absorption spectral microscopy device and a sum-frequency generation spectral microscopy device.

A light source 3 includes two types of light sources, that is, a first light source 31 and a second light source 32. A signal detector 5 includes a light detector 51 and a wave detector 52.

The first light source 31 and the second light source 32 are laser light sources having different output wavelengths. Output light beams form pulse trains.

These light pulse trains are ultrashort pulses whose pulse widths are typically on the order of from picoseconds to femtoseconds. The light intensity of the second light source is constant, whereas the light intensity modulation of the first light source is performed with a frequency f. In order to change a measurement wave number, a control PC 6 controls an output wavelength of the first light source 31 and an output wavelength of the second light source 32.

As the first light source 31, for example, a wide bandwidth light source, such as a fiber laser having a center wavelength of on the order of 1000 nm is used. As the second light source 32, for example, a fixed light source, such as a titanium-sapphire laser that excels in light intensity stability and that has a center wavelength of on the order of 800 nm is used. An output frequency variable mechanism is built in the light source 3. If switching is performed between light sources having different center wavelengths for using the switched light source, a measurement wave number range can be increased.

The details of a microscope section 4 are described with reference to the schematic view of FIG. 4B.

A first objective lens 42 for light illumination and a second objective lens 43 for converging light are disposed so as to oppose each other. As these objective lenses, objective lenses based on a specification for transmission of near infrared light are used.

A specimen table 41 is set between these opposing objective lenses. A specimen is placed on, for example, a preparation, and is secured to the specimen table 41. The specimen table 41 is secured to a movement stage 21. The movement stage 21 has a Z movement function of moving the specimen table 41 between the objective lenses 42 and 43 in an optical axis direction and an XY movement function of moving the specimen in directions perpendicular to direction Z, that is, in an in-plane direction of a surface of the specimen. The movement stage 21 is used for moving an observation area.

Lights from these two light sources are coaxially multiplexed, and are introduced into an optical system of the main body of the microscope. The light from the first light source 31 and the light from the second light source 32 are multiplexed on a same optical axis by, for example, a mirror 45 and a half mirror 44, and are guided to an optical scanner 22. The optical scanner 22 is controlled by the PC and is used for scanning a light path in directions X and Y. Although the optical scanner may be, for example, a galvanometer scanner, a polygon mirror, or an optical microelectromechanism system (MEMS) mirror, the optical scanner is not particularly limited thereto.

Light passed through the optical scanner 22 is converged on the specimen by the first objective lens 42. The control PC 6 outputs position specifying information to the movement controller 2. The movement controller 2 controls the movement stage 21 and the optical scanner 22, and laser light illuminates an arbitrary position on the specimen.

An observation area can be moved by moving a stage, moving a laser scanning area, or by performing a combination of these as appropriate. The method of moving the observation area is not particularly limited.

Although, as the movement stage, a screwing type or a rack-and-pinion type may be used, a movement stage provided with an actuator using, for example, a stepping motor, an ultrasonic motor, or a piezoelement is desirably used from the viewpoint of performing precise movement control.

It is possible to scan an inner portion of an observation area and to move the observation area by only moving a laser illumination position. For example, as a drive signal of the optical scanner, a signal formed by multiplexing a scanning signal having a small displacement amount for observing the inner portion of the observation area and a signal for moving the observation area is input. Alternatively, the observation area may be moved by moving the laser illumination position as a result of changing the angle of a mirror inserted between the optical scanner and objective lens.

Further, if an optical system having a wide angle of view and including an objective lens based on a specification for transmitting infrared light corresponding to a laser scanning range of on the order of 1 mm or wider is used, it is possible to move a wider area by performing only laser scanning.

At a focal portion, a stimulated Raman scattering phenomenon occurs, and the laser light is subjected to intensity modulation depending upon the amount of scattering.

The stimulated Raman scattering phenomenon occurs when the difference between the frequencies of the lights from the two light sources matches the frequency of the vibration of molecules in the specimen.

Of the laser lights that have passed through the specimen, only the laser light having one of the wavelengths is separated by an optical filter 46, and is detected by the light detector 51 (comprising, for example, a photodiode). Its light intensity is converted into a voltage and output.

A signal from the light detector 51 is sent to the wave detector 52 where a modulated signal (frequency f) from the first light source 31 is subjected to synchronous wave detection as a reference signal, so that a modulation component is output as a Raman signal (nonlinear Raman scattering signal).

The output Raman signal is input to an input port of the control PC 6. The control PC 6 generates and stores data in which position information, light wavelength information, and input signals from the signal detector have been integrated. By obtaining a Raman signal while changing wave-number and measurement position, a Raman spectrum spatial distribution is obtained.

If a resonant galvanometer scanner (resonant frequency is on the order of 8 kHz) that is capable of high-speed light scanning is used as the optical scanner 22, when the number of scanning lines per image frame is on the order of 500 lines, it is possible to perform video-rate measurements of approximately 30 frames/second.

The stimulated Raman spectral microscopy device according to the embodiment has the function of switching a spectral measurement condition when an observation area is moved and when the observation area is fixed in response to the movement controller 2. This function allows an operation that is the same as that according to the first embodiment to be performed, so that this function is not described.

According to the embodiment, even in a spectral microscopy device that makes use of a nonlinear optical phenomenon using two light sources, as typified by, for example, a stimulated Raman spectral microscopy device, images of measurement results can be speedily displayed with good followability with respect to the movement of an observation area while moving the observation area. Therefore, it becomes easy to search for an observation area to be subjected to a desired detailed observation.

### Third Embodiment

An exemplary structure in which a multivariate analysis is used for spectral analysis is described as a third embodiment.

For example, a multivariate analysis, such as a principal component analysis, an independent component analysis, a multiple-regression analysis, or a discriminant analysis, may be performed for analyzing spectral data including multi-dimensional components obtained in the embodiment.

If multivariate analysis is performed, even for a sophisticated multispectrum that is derived from a plurality of signal sources, it is possible to separate and extract a signal source.

The principal component analysis is a technique for obtaining a new classification index from multivariate data. The independent component analysis is a technique for restoring an independent signal source using only an observation signal by conversion that allows a signal to be independent. The multiple-regression analysis is a technique for obtaining the relationship between a spectral component and a signal source and determining the signal source. The discriminant analysis is a technique for identifying, from characteristics of target such as spectral data, what group the target belongs.

If the principal component analysis is taken as an example, orthogonal basis vectors that are the same in number as dimension n of data are determined, and are defined as a first principal component to an nth principal component sequencially from the vector having a large variance to that having a small variance.

A top principal component is often used as a component that represents characteristics of an analysis target well. In, for example, the principal component analysis, it is necessary to determine the same number of basis vectors as the dimensions of an obtained signal. As a result, it has the problem that, as the number of dimensions of signal data, that is, the number of measured wave numbers increases, the amount of calculation increases. Therefore, in order to reduce the amount of time of analysis, it is effective to reduce the number of measurement wave numbers.

Accordingly, in the embodiment, when an observation area is moved, by minimizing the number of measurement wave numbers, the amount of time of measurement and the amount of time of analysis are shortened, and the results of analysis can be displayed with good followability with respect to the movement of the observation area.

When an observation area is fixed, a large number of measurement wave numbers that are selected are set to allow detailed spectral measurement and analysis.

For example, when the technique in Non Patent Literature 1 is used, a video-rate measurement of approximately 30 frames/second can be performed. The wave number can also be changed with each frame.

When this technique is used, the time required for multivariate analysis, such as principal component analysis, is short if the number of wave numbers is a few wave numbers. Therefore, it is possible to substantially perform real-time display in accordance with the movement of the observation area.

When the number of measurement wave numbers is increased, the followability of the display of results with respect to the movement of the observation area is reduced. However, it is possible to perform a more detailed display by color. The multivariate analysis can be performed as long as there is information obtained by at least two wave numbers. An operator may set, as appropriate, the number of wave numbers that are selected considering the amount of measurement time and analysis time.

When the observation area is fixed, it takes time to perform measurement and analysis when the number of measurement wave numbers that are selected is large. However, since the observation area is fixed, followability with respect to the observation area does not become a problem. As long as the number of measurement wave numbers that are selected is on the order of 100, the spectral microscopy device according to the embodiment can display the results of measurement and analysis within a few seconds.

In the foregoing description, the case in which a small number of measurement wave numbers is set when an observation area is moved is described. However, if only some of the wave numbers among the wave numbers that have been measured are used for analysis, it is possible to further reduce processing time by reducing the time taken for analysis.

Here, regarding the wave number values and the number of wave numbers that are selected used in the analysis, the wave numbers may be previously selected at equal intervals, or particular wave numbers may be previously set at unequal intervals. In the latter case, the wave numbers that are selected may be determined using spectral information regarding a known material.

According to the embodiment, when an observation area is moved, image display which presents spatial distribution of structural components, for example, with colors can be speedily performed with good followability with respect to the movement of the observation area. Therefore, it becomes easy to search for a desired observation area to be subjected to a detailed observation.

### Fourth Embodiment

An exemplary structure that changes a wave number that is measured when an observation area is moved and when an observation area is fixed is described as a fourth embodiment.

In the embodiment, a wave number that is measured is set so as to be changed when an observation area is moved and when an observation area is fixed.

Here, for example, when an observation area is moved, a wave number that allows a strong signal to be obtained is selected as appropriate and the area is speedily generally viewed; and, when the observation area is fixed, a wave number that is derived from a desired particular material is selected and set.

Alternatively, if observation is to be performed on biological tissue, it is possible to switch between wave numbers, in which a wave number that is suitable for extracting a cell outline when an observation area is moved is selected, and a wave number that is suitable for extracting the internal structure of a cell when the observation area is fixed is selected. This is only one example. The wave number to be set is selected as appropriate in accordance with the purpose.

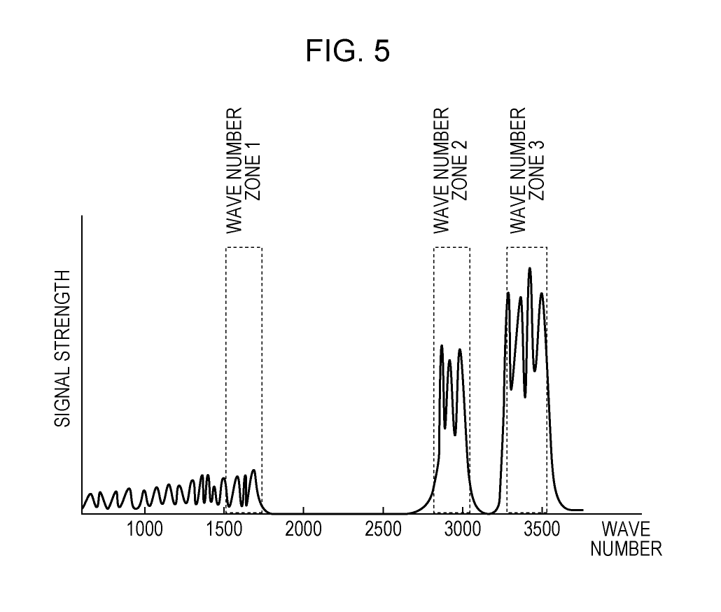

Further, an exemplary structure in which a wave number domain is changed to, for example, a CH stretching vibration region or a fingerprint region is described with reference to FIG. 5.

In the embodiment, when a wave number that is measured is changed when an observation area is moved and when the observation area is fixed, a wave number domain in which a wave number is selected is changed. More specifically, as shown in FIG. 5, it is known that, in a Raman spectrum regarding biological tissue, a wave number domain that is close to a fingerprint region (650 to 1500 cm⁻¹) or close to a stretching vibration region (1500 to 4000 cm⁻¹) is primarily known. The fingerprint region is a region in which a spectrum that is characteristic of a material appears in detail and is useful for identifying the material. The stretching vibration region is a spectrum that reflects only stretching vibration, and is a relatively simple profile.

In particular, since, in biological tissue, the primary structural components are, for example, fat and protein, a strong peak that is derived from CH stretching vibration is formed near 2800 to 3000 cm⁻¹ in the Raman spectrum.

Since a signal that is derived from a minute structural difference is superposed upon a signal in this wave number domain, the spectrum is broad. Although this signal is disadvantageous in identifying materials, it is useful for, for example, generally viewing the forms of cells or cell distribution. Since a strong signal is obtained, the number of signal integrations can be small.

A signal in the fingerprint region is advantageous in identifying materials, and is useful for, for example, extracting a detailed distribution of a particular material. However, signal strength in biological tissue is low, as a result of which a large number of signal integrations may be required.

Examples of setting wave number domains are shown as domains 1 to 3 in FIG. 5.

The domain 1 is an example in which part of a fingerprint region is selected. The domain 2 is an example in which a CH stretching vibration region is selected. The domain 3 is an example in which an OH stretching vibration region is selected.

In the embodiment, for example, when an observation area is moved, a measurement wave number is set so as to be selected from the domain 2 where a signal is strong, and, when the observation area is fixed, a measurement wave number is set so as to be selected from the domain 1 that is superior in materials identification ability.

At this time, the number of wave numbers that are selected when the observation area is moved may be more than one, and integration may be performed. However, from the viewpoint of speedy measurement, it is desirable to reduce the number of wave numbers that are selected and, since a signal is strong, the number of integrations.

When the observation area is fixed, from the viewpoint of increasing the precision of identification, it is desirable that many measurement wave numbers be selected and, since a signal is weak, a plurality of integrations be performed.

### Fifth Embodiment

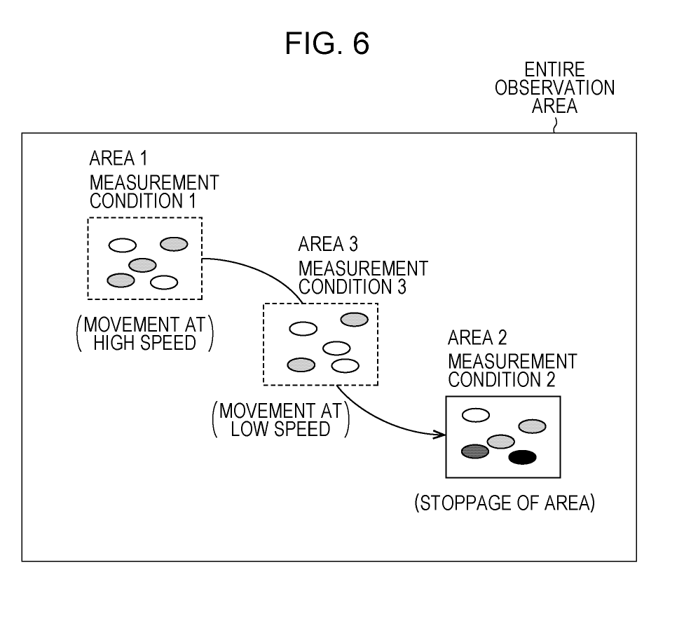

An exemplary structure for automatically switching between measurement conditions in a plurality of steps in a two-dimensional plane (XY directions) is described as a fifth embodiment with reference to FIG. 6.

Although the microscope devices according to the embodiments described above are configured to switch the measurement condition when an observation area is moved and when the observation area is fixed, a microscope device according to the fifth embodiment is configured to automatically switch the measurement condition in multiple steps in accordance with a speed of movement specified by a movement controller 2.

Switching measurement conditions in accordance with movement speed is schematically shown in FIG. 6.

That is, switching is performed between measurement conditions 1 to 3 as shown below in accordance with the movement speed. Here, although three steps are shown, measurement conditions may be switched in a larger number of steps, or in a stepless manner.

Here the number of measurement wave numbers that are selected is the measurement condition that is switched. When high-speed movement is specified, the number of measurement wave numbers that are selected is set small (measurement condition 1); when low-speed movement is specified, the number of measurement wave numbers that are selected is set large (measurement condition 3); and when an observation area is fixed, the number of measurement wave numbers that are selected is set even larger (measurement condition 2).

Hereunder, setting examples when a stimulated Raman spectral microscopy device is used are described.

Here, an observation area is moved in an X-Y plane. The same way of thinking can also be applied to movement in direction Z as appropriate. The maximum frame rate is expressed in m-F-Rate [frame/sec], the movement amount (movement step amount or display shift amount is expressed in frame units) is expressed in D[frame], and the movement speed that is specified by a movement control device is expressed in S[frame/sec]. The number of integrations per wave number is M. The number N of measurement wave numbers is determined as follows:

N=[m-F-Rate×D/S/M]

However, the fractional portion of the number is dropped.

However, when the following condition is followed, N is fixed to 1:

S is greater than or equal to m-F-Rate×D/M

When structural components are to be displayed by color, it is necessary that N be greater than or equal to 2. However, in the next condition, N is fixed to 2:

S is greater than or equal to m-F-Rate×D/M/2.

Further, the case in which the number of measurement wave numbers that are selected is limited to N_max is described.

In a range of the condition N_max is less than or equal to [m-F-Rate×D/S/M], the movement amount D may be automatically changed in accordance with the following formula:

D=N_max×S×M/m-F-Rate

Typically, m-F-Rate is set to a value of 1 to 30, D is set to a value of 1/100-10, S is set to a value of 0-10, and N_max is set to a value on the order of 1-100.

When a position controller is a mouse and movement is specified by a dragging operation, the movement speed of an observation area can be set so as to be generally in proportion to the dragging speed.

As described above, spectral measurement at a two-dimensional area can be performed by automatically changing the measurement condition in accordance with the specified movement speed without loss of followability with respect to the movement of an observation area.

### Sixth Embodiment

An exemplary structure that moves an observation area in a one-dimensional direction (linear direction) or in three-dimensional space is described as a sixth embodiment.

Although, in the fifth embodiment, the exemplary structure that moves an observation area in a two-dimensional plane (XY directions) is described, it is possible to cause the observation area to also move in a direction Z, so that it moves in three-dimensional space.

At this time, a position control device may be provided, not only with the function of moving an observation area in the XY directions, but also with the function of specifying movement of the observation area in a direction Z. Alternatively, the position control device may be applied to the case in which the observation area is set one-dimensionally, that is, linearly.

A case in which, with an observation area being set in a one-dimension, the number of measurement wave numbers that are changed for obtaining spectral information is automatically switched on the basis of a state of linear movement is hereunder described.

(1) When an observation line (segment) is moved: The number of measurement wave numbers is set to a small value. However, the number of measurement wave numbers is at least two. Until measurement under a set measurement condition is completed, the movement of a movement stage is stopped. That is, it is desirable to repeat the movement of the observation line in steps along each line.

(2) When an observation line is fixed (or its movement is stopped): The number of measurement wave numbers is set larger than the number of measurement wave numbers that is set when an observation line is moved. Here, by setting a larger number of measurement wave numbers than when an observation line is moved, it is possible to obtain a more detailed spectrum.

As described above, the present invention is applicable to any one of the one-dimensional to three-dimensional observation areas.

### Seventh Embodiment

A method for specifying an observation area for making it possible to follow a measurement object that moves, such as living things, is described as a seventh embodiment.

It is assumed that observation results of an initial observation area are displayed on a monitor screen. An observation area is an area that is surrounded by, for example, a square. A cursor that typifies position information of an observation area is displayed at a central portion of the observation area on a monitor screen.

An operator operates an observation area specifying mechanism, and moves a display position of a cursor. The position where the cursor has been stopped is set at a new central position of an observation area. For example, if an observation object is moved, the cursor is moved so that the moved observation object is included in the observation area.

Another method for specifying an observation area is described. It is assumed that observation results of an initial observation area are displayed on a monitor screen.

An operator operates a position control device, and moves a display position of a cursor. The position of the cursor is determined every previously set time interval (for example, 0.2 seconds) and is set.

Information regarding the set position is sent to a movement stage and the stage is moved to perform spectral measurement at an observation area around a newly set position.

After spectral measurements and data analyses in the observation area have been completed, it is necessary to move to a next observation area. Therefore, a time interval for determining the position is set longer than the time required for the measurements and analysis.

The above-described method makes it possible to, for example, ceaselessly make measurements while following a moving object, such as living things. If a control PC 6 is provided with an image processing unit that is capable of performing ordinary image recognition techniques, it is possible to recognize, for example, a cell outline shape or a cell nucleus shape and, with these shapes as reference points, to automatically follow an observation object.

### Eighth Embodiment

An exemplary structure that switches an analysis method (analysis condition) when an observation area is moved and when the observation area is fixed is described as an eighth embodiment.

For example, when an observation area is moved, a plurality of measurement wave numbers are used, a simple analysis, such as comparing the strengths of signals for corresponding wave numbers or comparing strength ratios of signals between the plurality of measurement wave numbers, is carried out, and structural components are simply separated.

Compared to, for example, multivariate analysis, this method is advantageous in that the amount of analysis time is short and is convenient for speedily displaying the results of analysis when an observation area is moved.

In contrast, when the observation area is fixed, in order to perform a higher definition spectral analysis, the number of measurement wave numbers is set larger than that when an observation area is moved, and a multivariate analysis is performed. The multivariate analysis is selectable from various analysis methods, such as a principal component analysis, an independent component analysis, a multiple-regression analysis, a factor analysis, a cluster analysis, and a discriminant analysis.

Results of the analysis are displayed by color as differences of structural components. Although it takes a long time to perform multivariate analysis when the number of spectral measurement points is large, followability does not become a problem when an observation area is fixed.

The multivariate analysis technique may be switched when an observation area is moved and when the observation area is fixed. For example, when an observation area is moved, a principal component analysis having relatively few calculations may be performed, and, when the observation area is fixed, an independent component analysis that takes time to perform may be performed.

When an observation area is moved or is fixed, a combination of a plurality of multivariate analysis techniques may be performed. In particular, when an observation area is fixed, for example, it is possible to expect an increase in identification accuracy of materials by performing a combination of principal component analysis and independent component analysis.

Data obtained when an observation area is moved or results of analysis of the data thereof may be used for analysis when the observation area is fixed. In particular, multivariate analysis or the like is effective in reducing the time required for performing analysis when the observation area is fixed.

When an observation area is moved, it is possible to successively integrate pieces of data obtained on the basis of rough measurement wave numbers and to compile the pieces of data based on many measurement wave numbers for performing analysis. Further, when a newly obtained observation area at the time of movement is analyzed using the results of analysis of the integrated pieces of data, it is possible increase the precision with which components of a specimen are separated while suppressing an increase in the time required for the analysis.

When, for example, a principal component analysis or an independent component analysis is performed, if score values for data obtained at a new observation area is determined using basis vectors obtained by analysis of previously obtained integrated data, it is possible to reduce the amount of analysis time. Here, it is effective to derive the basis vectors at the same as the obtainment of data.

Analysis techniques that may be used when an observation area is moved or fixed may be selected from a plurality of alternatives, and are not limited to those above.

### Ninth Embodiment

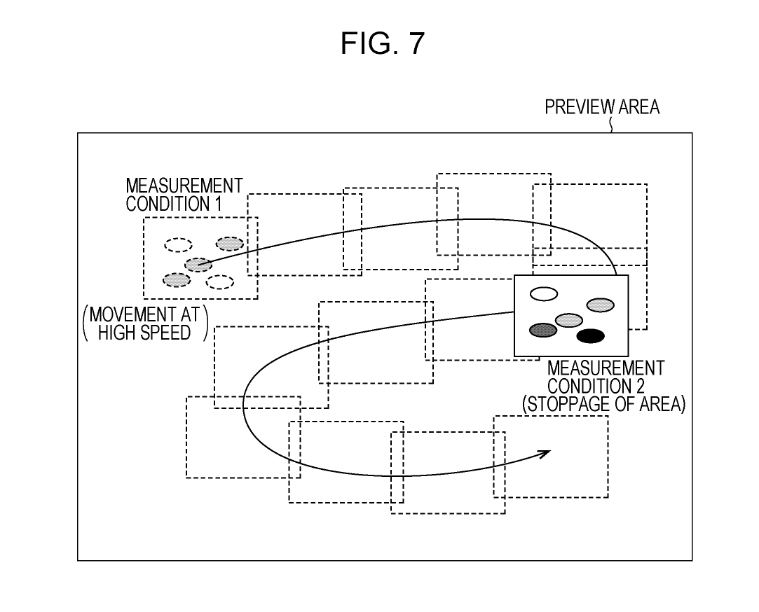

A structure that allows a wide-area preview display to be performed by observing narrow areas while moving through the narrow areas is described as a ninth embodiment with reference to FIG. 7.

When the magnification of an objective lens is fixed, an observable maximum area is limited. Ordinarily, in order to generate a signal, an objective lens having a high light-converging capability and a high NA is used. Such an objective lens provides a high spatial resolution, but a measurement area is narrow. An effective measurement area when a commercial immersion objective lens having a magnification of ×60 and an NA of 1.2 is used is limited to approximately 100 micrometers squared. In order to have a preview of a wide area over a few millimeters squared, it is necessary to form combined images of many narrow areas.

In order to realize both a detailed observation and a preview display not causing stress to an observer, a function for performing the following measurements is provided.

(1) When preview measurement is performed: Adjacent or discrete narrow areas are observed while successively moving through them, and combined images disposed in correspondence with the positions of many observation areas on a specimen are formed. The narrow areas are two-dimensional or three-dimensional areas, and movement therethrough is performed by moving a stage. At this time, it is possible to measure a wide area in a short time by setting the number of measurement wave numbers small. Although an observation area may be previously set, it is possible to successively specify narrow areas along a path followed by an operation of, for example, a mouse performed by an observer. Observation results may be displayed by displaying images that are successively placed side by side for corresponding observations of narrow areas. Alternatively, observation results may be displayed all at once by combined images after completion of the observation of a wide area. Analysis may be performed for each narrow area to display images of the results of analysis. Alternatively, it is possible to compile pieces of data of a wide area after completing measurement of the wide area, and, then, display images of the results of analysis. It is possible to, by performing multivariate analysis or the like, roughly distinguish matter and separate the distribution, and display the results of analysis, for example, by color.

(2) During regular measurement: One narrow area is selected from a preview image of a wide area, or a new fixed area is set on a preview image of the wide area, to perform a detailed measurement on the narrow area under a measurement condition that differs from that during the preview measurement. In the regular measurement, the number of measurement wave numbers that is larger than the number of measurement wave numbers during the preview measurement is set to perform a detailed spectral distribution measurement. Here, if a detailed spectral analysis is performed by performing, for example, multivariate analysis, it is possible to distinguish between matter distributions in detail and display the results of analysis, for example, by color.

According to the embodiment, it is possible to provide a spectral microscopy device that is capable of speedily displaying a preview of a wide area when, for example, searching for a desired observation area.

### Tenth Embodiment

This embodiment provides the function of switching the number of measurement points in addition to the number of measurement wave numbers as a measurement condition when an observation area is moved and when the observation area is fixed. A plurality of measurement wave numbers may be set for one measurement point, or a plurality of measurement points may be set for one wave number that is set.

If the number of measurement points is small, it is possible to considerably reduce the amount of measurement time, which is highly effective in that a substantially real-time display is possible by following the movement of the observation area. When the number of measurement points is small, the spatial resolution is reduced. However, for preliminary measurement when a detailed observation area is searched for while moving an observation area, all that is needed is to obtain information required for roughly distinguishing between different types of materials that exist.

In contrast, when the number of measurement points is large, the time required for measurement and analysis is increased. However, a detailed spectrum can be obtained with higher spatial resolution. However, when an observation area is fixed, followability with respect to the movement of the observation area does not become a serious problem.

The following operation modes are settable.

(1) The number of measurement wave numbers when an observation area is moved is smaller than that when the observation area is fixed. However, the number of measurement points when the observation area is moved is the same as that when the observation area is fixed.

(2) The number of measurement points when an observation area is moved is smaller than when the observation area is fixed. However, the number of measurement wave numbers when the observation area is moved and that when the observation area is fixed are the same.

(3) The number of measurement points and the number of measurement wave numbers when an observation area is moved are smaller than those when the observation area is fixed.

In any of these modes, it is possible to reduce the time required for measurement and analysis when the observation area is moved. Therefore, it is possible to speedily display the results of analysis. In particular, the mode (3) is highly effective in reducing the amount of time of measurement and analysis, and is particularly effective when performing stereoscopic observation in a depth direction.

Although, in the embodiment, the number of measurement wave numbers and the number of measurement points are measurement conditions that are switched when an observation area is moved and when the observation area is fixed, various other combinations are possible as measurement conditions. That is, a combination of at least two or more measurement conditions can be selected from, for example, measurement wave number, the number of measurement wave numbers, the number of measurement points, and the number of integrations.

An observation area may be applied, not only to a two-dimensional plane (XY directions), but also to three-dimensional space. Here, the position control device may be provided with the function of, not only moving an observation area in the XY directions, but also specifying movement of the observation area in direction Z.

Even in any of the observation modes according to the embodiment, images of measurement results can be speedily displayed with good followability with respect to the movement of an observation area that is moved. Therefore, it becomes easy to search for an observation area to be subjected to a desired detailed observation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-113147, filed May 29, 2013, which is hereby incorporated by reference herein in its entirety.

### REFERENCE SIGNS LIST

1 Light detector
2 Movement controller
3 Light source
4 Microscope section
5 Signal detector
6 Control PC
7 Output display
8 Observation area specifying mechanism

1. A spectral microscopy device comprising:
a spectral detecting unit including a light source that is capable of controlling an output wavelength, a microscope section that is provided with an observation area that is illuminated with light output from the light source, and a signal detector that detects light from the observation area as spectral data;
a moving unit configured to move the observation area; and
a controller that performs a control operation to allow the spectral detecting unit and the moving unit to move in response to each other,
wherein the spectral microscopy device is controlled so that switching between different measurement conditions is performed at an observation area movement time in which the observation area is moved by the moving unit and measurement is performed and at an observation area movement stoppage time in which the observation area is fixed and measurement is performed.

2. The spectral microscopy device according to claim 1, wherein the controller includes an analyzing unit configured to analyze the spectral data detected by the spectral detecting unit and output a result of the analysis as a spectral image.

3. The spectral microscopy device according to claim 2, wherein the spectral image that is output by the controller is obtained by analyzing spectral data based on at least two wave numbers of the light output from the light source.

4. The spectral microscopy device according to claim 2, further comprising a display configured to display the spectral image that is output by the controller.

5. The spectral microscopy device according to claim 1, wherein the spectral detecting unit is capable of detecting a signal based on a nonlinear optical phenomenon.

6. The spectral microscopy device according to claim 1, wherein the light source includes two light sources that output two different wavelengths.

7. The spectral microscopy device according to claim 6, wherein the spectral detecting unit is capable of detecting a nonlinear Raman scattering signal.

8. The spectral microscopy device according to claim 1, wherein a measurement condition when switching between the different measurement conditions is the number of wave numbers that are selected, and wherein the number of wave numbers that are selected at the observation area movement stoppage time is set larger than that at the observation area movement time.

9. The spectral microscopy device according to claim 1, wherein a measurement condition when switching between the different measurement conditions is a wave number.

10. The spectral microscopy device according to claim 1, wherein a measurement condition when switching between the different measurement conditions is a wave number domain for selecting a wave number, wherein, at the observation area movement stoppage time, a wave number in a fingerprint region is selected and set, and, wherein at the observation area movement time, a wave number in a stretching vibration region is selected and set.

11. The spectral microscopy device according to claim 1, wherein a measurement condition when switching between the different measurement conditions is the number of integrations when measurement is performed with respect to a same measurement wave number a plurality of times and output signals are integrated, and wherein the number of integrations at the observation area movement stoppage time is larger than the number of integrations at the observation area movement time.

12. The spectral microscopy device according to claim 1, wherein a plurality of measurement conditions when switching between the different measurement conditions are selected from the number of measurement wave numbers, a measurement wave number, the number of integrations, and the number of measurement points.

13. The spectral microscopy device according to claim 2, wherein the controller is configured to perform a control operation to allow the analyzing unit and the moving unit to move in response to each other, and switching is performed between analysis conditions at the observation area movement stoppage time and the observation area movement time.

14. The spectral microscopy device according to claim 13, wherein, when switching between the analysis conditions, a multivariate analysis is performed by performing a principal component analysis or an independent component analysis at least at the observation area movement stoppage time, and strengths of signals having different wave numbers are compared and analyzed at the observation area movement time.

15. The spectral microscopy device according to claim 13, wherein the analysis conditions that are switched are selected from a same type or different types of multivariate analysis techniques, and a result of analysis at the observation area movement time is used for analysis at the observation area movement stoppage time.

16. The spectral microscopy device according to claim 1, wherein a measurement condition at the observation area movement stoppage time is set on the basis of a result of measurement at the observation area movement time.

17. The spectral microscopy device according to claim 1, wherein, at the observation area movement time, narrow areas are measured while successively moving through the narrow areas, and previews of results of observations of the areas are displayed as images of a wide area in which the results are provided side by side so as to maintain a relationship between observation positions on a specimen, and wherein, from the areas whose previews are displayed, a target area that is measured is selected by fixing the observation positions.

18. The spectral microscopy device according to claim 12, wherein a measuring unit or the analyzing unit is configured so that a processing operation is performed using FPGA or ASIC.

19. The spectral microscopy device according to claim 1, wherein the observation area is any one of a one-dimensional observation area to a three-dimensional observation area.
